(19) United States
(12) Patent Application Publication
(10) Pub. No.: US 2016/0258455 A1
(43) Pub. Date: Sep. 8, 2016

(54) MULTIFUNCTIONAL STRAP

(71) Applicant: HUI YU CHANG, TAIPEI CITY (TW)

(72) Inventor: HUI YU CHANG, TAIPEI CITY (TW)

(21) Appl. No.: 15/044,245

(22) Filed: Feb. 16, 2016

(30) Foreign Application Priority Data
Mar. 4, 2015 (TW) 104203231

(51) Int. Cl. F16B 2/08; G02C 3/00; F16M 13/02; A41D 13/11; F16B 47/00; F16B 45/00

(52) U.S. Cl. CPC F16B 2/08; F16B 47/00; F16B 45/00; F16M 13/022; A41D 13/1161; G02C 3/003; G02C 3/006; G02C 2200/16

(57) ABSTRACT

The present invention provides a multifunctional strap, made of elastic material, mainly provided with a main body of appropriate length and elasticity, and a plurality of threading holes of appropriate size extended from the two ends of the main body. Each of the threading holes can directly fix and position various articles. Furthermore, any of the threading holes can be bonded with at least one connecting component, or multiple connecting components bonded to each other, and the connecting component is used to hook or clasp articles. Based on the above, the present invention provides features of multiple functions, wide applications and comfortable use.

### BACKGROUND OF INVENTION

1. Field of the Invention

The present invention relates generally to a connecting rope, and more particularly to an elastic strap having multiple threading holes for bonding with connecting components to infinitely extending the overall length, so as to provide convenience for fixing or connecting various or multiple articles. It features multiple functions, wide applications and comfortable use.

2. Description of Related Art

Nowadays, glasses have become an everyday use for many modern people in their daily life. Apart from glasses for the myopia or presbyopia to correct eyesight, there are also other kinds of glasses, for example, sun glasses for shading the sun when going out, or sport glasses for leisure and protection or for sport use. In order to see clearly or to protect the eyes, the users have to wear glasses even though wearing glasses might cause inconvenience. Especially during walking, working or sport, the glasses may easily drop and break.

To prevent drop and break, usually a glasses rope is fitted between the two temples of the glasses, so as to connect the glasses to the wearer. In case the glasses accidentally fall off, the rope can hang the glasses on the neck of the wearer, so the glasses will not fall to the ground and be damaged. There is another kind of glasses rope to be used during sport. It is shorter and made of an elastic strap. It wraps the glasses on the head of the user so that the glasses will be fixed and will not drop. Different ropes shall be used for different purposes. Frequent change of the ropes is truly an inconvenience.

Also, an ordinary earplug used during swimming is just plugged into the ear canal of the swimmer and may easily fall off and drop into the water. Buying new earplugs frequently is truly a trouble for users! Moreover, articles wearing on the ears like a mask may fall off if the rope is not tight enough. However, if the rope is too tight, it may hurt the ears and the user may hate to wear it. Earphones or headphones are the same case. Too tight plugging or wearing may cause discomfort to the ears. If too lose, they will fall off easily. This problem really troubles the users.

Thus, to overcome said problems of the prior art, the inventor has provided the present invention of practicability after deliberate design and evaluation based on years of experience in the production, development and design of related products.

### SUMMARY OF THE INVENTION

The main objective of the present invention is to provide a multifunctional strap made of an elastic strap with a plurality of threading holes for fixing, connecting or positioning glasses temples, earplugs, eye masks, earphones or headphones, napkins, dental anti-spill paper etc, and which can be infinitely extended when bonded with connecting components, so as to provided multiple functions such as hooking or hanging articles.

Therefore, to fulfill said objective, the present invention provides a multifunctional strap made of elastic material, which mainly includes a main body of an appropriate length, and a plurality of threading holes of appropriate size extending from the two ends of the main body. The threading holes can be used to directly fix or position articles. Or, they can also be bonded with fasteners.

### BRIEF DESCRIPTION OF THE DRAWINGS

FIG. 1 is a perspective view of a preferred embodiment of the present invention.

FIGS. 2 to 5 is an operational view of a preferred embodiment of the present invention.

### DETAILED DESCRIPTION OF THE INVENTION

In order for your esteemed auditors to further and better understand and recognize the characteristics and features of the present invention, the following preferred embodiment is described with reference to the accompanying drawings:

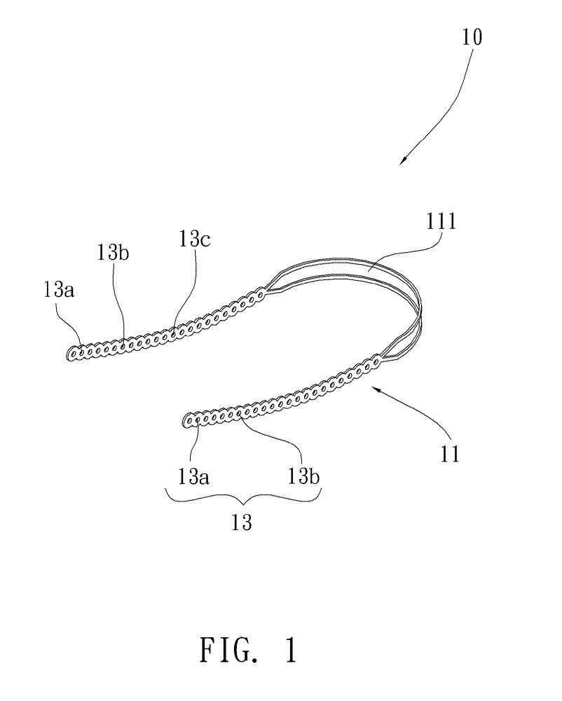

Referring to FIG. 1, the multifunctional strap 10 in the preferred embodiment of the present invention is made of elastic material, such as silicon or rubber, which has appropriate elasticity and ductility, as well as appropriate friction on the surface, and which mainly includes a main body 11 of an appropriate length. The main body 11 is geometrically formed in the shape of a plate. For the purpose of description, a rhombus is used in the present embodiment. It is thick and wide, with a hollow portion 111 configured in the center, so that, when the main body 11 contacts any part of the user's body, such as head or neck, the tightening force of the elastic material can be alleviated. Because of the hollow portion 111, the contacting area subject to the pressing force is reduced. When wrapped on the head of the user, it will expand to fit the shape of the user's head. In case of any head shape, the wearing will be fit and comfortable and the pressure can be alleviated. Moreover, extending from the two ends of the main body 11, there is a plurality of threading holes 13a, b, or c of appropriate size. The number of threading holes 13a, b, or c is not limited, because any one of the threading holes 13a, b or c can be used to directly put through and position the article, also because the multifunctional strap 10 of the present invention is made of elastic material, and the threading holes 13a, b or c can overlap to put through the article all at once so as to shorten the overall length of the multifunctional strap 10 of the present invention. When it is needed to increase the length, another multifunctional strap 10 can be added by connecting the threading holes 13 on each of them with other components (not shown in the drawing). In this way, it can be extended infinitely to accommodate various needs of various people.

Based on the above, the multifunctional strap 10 of the present invention has a wide range of application:

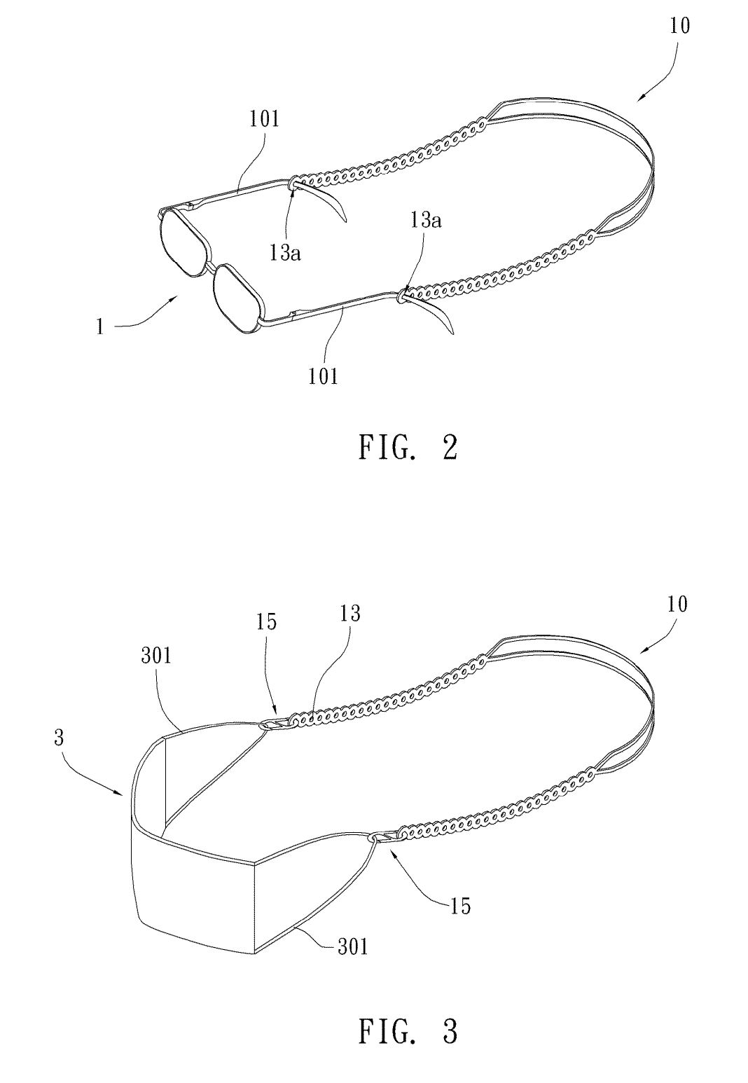

Referring to FIG. 2, when used for wearing glasses 1, the two temples 101 of the glasses 1 can be put through any of the threading holes 13a, b, c on the two ends of the main body 11, and depending on the strap length needed by the user, the threading holes 13a, b or c can overlap and let through the temples 101 all at once. In this way, the glasses 1 can be connected with the multifunctional strap 10 of the present invention. Moreover, because the overall length of the multifunctional strap 10 of the present invention can be adjusted to hang on the neck of the user, or be wrapped on the head of the user. Hence, no matter the user is walking, working or exercising, the glasses will not drop and break. Said problem can be thoroughly solved.

In addition, the multifunctional strap 10 of the present invention can also be bonded with a connecting component 15 through the threading holes 13 respectively on the two ends, so as to provide a hooking function through the connecting component 15; referring to FIG. 3, when it is used for a mask 3, the connecting component 15 bonding with the threading holes 13 is a clasp (the connecting method is not limited), and can hook the two ear-hang cords 301 on the mask 3. The main body 11 contacts and covers the head of the user, and the connecting component 15 (being a clasp) provided on the threading holes 13 on either end of the main body 11 connects the ear-hang cords 301 of the mask 3. The ear-hang cords 301 are wound on the ears of the users so that the mask can cover the mouth of the user. In this way, the mask can be used comfortably for a long period of time, without the problem of pain in the ears caused by the conventional masks with the ear-hang cords hung on the ears.

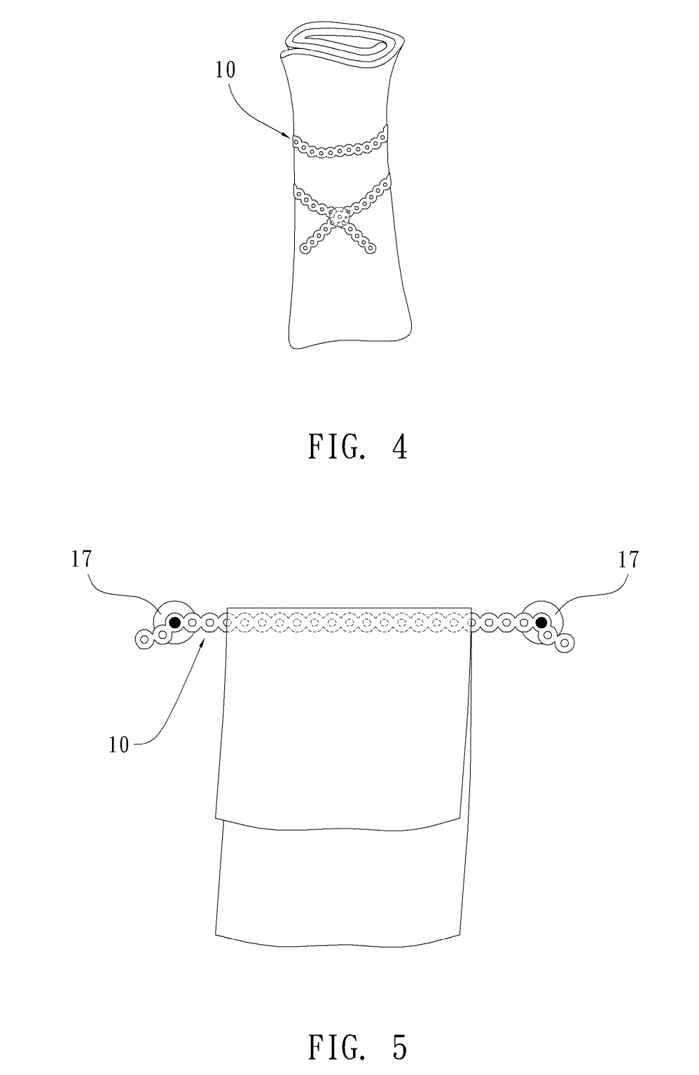

Of course, the multifunctional strap 10 of the present invention can be further used to wrap articles directly (or through clasps). As shown in FIG. 4, based on its elasticity, ductility and surface friction, the article can be wrapped firmly and effectively.

Referring to FIG. 5, the multifunctional strap 10 of the present invention can be further bonded with two hooking components 17 (such as suction cups or hooks, connecting methods are not limited). By fixing the two hooking components 17 on the wall, the multifunctional strap 10 can be used to hang towels, toilet paper, magazines etc or to hook other articles. Hence, it can also provide the function of a hanging frame.

Of course, based on the features of multiple holes, appropriate elasticity and ductility, the multifunctional strap of the present invention, it can also be used as a wrapping strap for earplugs, hangtags, ID cards, eye masks, earphone or headphones, napkins, dental anti-spill paper etc. The application range is very wide.

To summarize, the multifunctional strap of the present invention is characterized by a plurality of threading holes, an elastic and extendable structure, and an ability to bond with other connecting components or hooking components. It can be used to connect and wrap various articles such as glasses or earplugs. It can also provide multiple functions of hooking, clasping, hanging and suspending various articles. Furthermore, it can be bonded with connecting components to infinitely extend the overall length. Hence, it can truly accomplish the expected object of invention, and has the efficacy to enhance industrial competitiveness.

What is claimed is:

1. A multifunctional strap, made of elastic material, mainly provided with a main body of appropriate length and elasticity, and a plurality of threading holes of appropriate size extended from the two ends of the main body; each of the threading holes can directly fix and position various articles.

2. The structure defined in claim 1, wherein any of the threading holes can be bonded with at least one connecting component; said connecting component can be provided to extend the length, or to hook or clasp articles.

3. The structure defined in claim 1, wherein said main body is roughly in the shape of a plate, thick and wide, and provided with a hollow portion in the center.
